(19) United States
(12) Patent Application Publication
(10) Pub. No.: US 2008/0094990 A1
(43) Pub. Date: Apr. 24, 2008

(54) COMBINED FLUORESCENT-REFLECTIVE MEDIA AND MEDIA READING DEVICE

(76) Inventors: Alexey LEZHNEV, Moscow (RU); Galina Dorozhkina, Dolgoprodnij (RU); Mikhail Kvasha, Moscow (RU)

Correspondence Address: WINSTON & STRAWN LLP;PATENT DEPARTMENT, 1700 K STREET, N.W., WASHINGTON, DC, 20006, US

(21) Appl. No.: 11/873,954

(22) Filed: Oct. 17, 2007

(30) Foreign Application Priority Data
Oct. 18, 2006 (RU) RU 20061366889

(51) Int. Cl. G11B 3/74

(52) U.S. Cl. 369/94

(57) ABSTRACT

The invention relates to optical media of ROM, WORM, or RW type that combine the ability to write and read data from one layer using fluorescent and reflective methods. Data is recorded as pits of different depth situated either in two alternating spiral tracks or in the same track. Data is read either sequentially, e.g., first by a fluorescent signal, then by a reflective signal, or simultaneously by using two optical heads, one that is fluorescent and the other that is optical

### BACKGROUND

The present invention covers area of information-carrying media, to define more precisely area of optical information-carrying media, and to define even more precisely, an area of multilayer optical information-carrying media. Optical information-carrying media that uses reflective principle is well known—optical disks are the most widespread example.

In CD-ROM (“Compact Disc Read-Only Memory”) media data is recorded on the surface of the disk as array of the pits of defined size, set in spiral tracks. The design of such media does not allow the user to record data on it. The data is recorded only by the disk manufacturer and cannot be erased by the end user.

One-time recordable WORM-type (“Write Once Read Many”) and RW-type (“Rewritable”) disks contain spiral tracks filled with photosensitive material capable of storing data.

As an example, FIG. 1 shows structure of a typical ROM-type data layer. It consists of metallized disk (10) containing digital data encoded as sequence of data-carrying pits (11B) situated along the spiral tack (12), spreading from center (13) to perimeter.

Currently, main efforts of optical memory developers are aimed at the following areas:
Increasing stored data capacity;
Increasing reading (and writing—for WORM- and RW-type media) speed;
Increasing temporal media stability during long-term storage.

The stability of media depends chiefly on construction and composition of different elements.

Until recently, improvements in the first and the second areas were achieved by decreasing geometrical dimensions of basic data carrier (pit) (11) and distance (14) between data tracks (12) in data-layer (10). This is possible both with decrease of wavelength and with increase of optical system numeric aperture. In addition, a capacity increase can be achieved using a multilayer or three-dimensional structure of the media.

Technologies that allow increasing density and transfer speed of data from optical media are constantly being improved. This is shown in Table 1, which compares specifications of the most advanced ROM-type optical disks: DVD-ROM (“Digital Video Disc” or “Digital Versatile Disc”), HD-DVD (“High Density-DVD”) BD (“Blue-Disk”). As the Table 1 shows, the only common feature for those standards is the geometric size of the disk (120 mm).

But it is well-known according to the Rayleigh criterion that minimal size of Dₘᵢₙ of the focused spot is constrained by the diffraction limit value, which is defined by correlation between wavelength λ of writing/reading optical emission, and numeric aperture NA of the optical scheme:

Dₘᵢₙ=1.22λ/NA, (1)

Consequently, the area of focused light field is proportional to (λ/NA)². With traditional optical reading/writing devices, to increase data density without increasing disk size, wavelength must be decreased or numeric aperture must be increased, as done in HD-DVD and BD standards.

But high-aperture lens creates aberrational distortion (proportional to (NA)⁴), that decrease the stability of reading or writing. To counter these negative effects, special static or dynamic correctors (for example, liquid-crystal single lent memory (SLM) are used in single-lens optical memory systems and as is shown in US Patent application 2004/0125734).

Consequently, since all of the above-described optical disks store data on the surface of the media, maximum possible density is constrained by physical diffraction limit and is approximately 1 GB per cm².

TABLE 1

| No | Specification | CD | DVD | HD-DVD | BD |
|---|---|---|---|---|---|
| 1 | Single-layer disk | 0.68 | 4.7 | 15 | 23.3/25 |
| | capacity. | | | | |
| 2 | Laser wavelength, | 780 | 650 | 405 | 405 |
| | nm | | | | |
| 3 | Numeric aperture | 0.45 | 0.6 | 0.65 | 0.85 |
| | (NA) | | | | |
| 4 | Beam power, | — | — | 0.5 | 0.35 |
| | mWt | | | | |
| 5 | Minimum pit | 833-972 | 400-440 | 204 | 160 (23.3 GB) |
| | length (~2 bits), | | | (15 Γ6a [symbol] ) | 149 (25 GB) |
| | nm | | | | 138 (27 GB) |
| 6 | Distance between | 1600 | 740 | 400 | 320 |
| | tracks, nm | | | | |
| 7 | Data transfer | 1.47 | 11.08 | 36.5 (1X) | 36 (1X) |
| | speed, Mbit/sec | | | | 72 (2X) |
| | | | | | 54 (video BD- |
| | | | | | ROM) |

As can be seen, the data capacity of DVD-type disks with a red semiconductor laser (λ=650 nm), with standard distance between the tracks and disk diameter 12 mm is 4.7 GB. BD-type disks capacity with blue laser (λ=405 nm) with standard distance between tracks 0.32 mkm and disk diameter 12 mm is 25 GB. From the above if follows that the capacity of a single-layer disk depend on laser wavelength distance between tracks and pit size. Using laser with 405 nm wavelength instead of laser with 650 nm allows increasing disk (data layer) capacity up to 5 times.

But this requires significant change in numeric aperture NA of the focusing lens from 0.6 to 0.85 and thus, the lens must be physically situated right above the data plane, and this in turn makes disk manufacture more difficult, by requiring special hard surface cover, disk balance and planarity. All these factors call for search for alternative technical solutions that allow increasing optical disk capacity.

Increasing the number of reflective data layers can increase disk capacity. This approach is especially effective with 650 nm wavelength laser. Such technical solutions are described in U.S. Pat. No. 5,449,590 or EP Application 1419503. But because of high optical interference, the number of layers is very limited. This is especially true for shortwave lasers (380-410 nm).

An alternative technical solution to the reflective disk is fluorescent multilayer disks proposed by C3D Inc. [White paper. Technical report, Constellation 3D, June 2000; H. Coufal, G. W. Burr, Optical data storage”, International Trends in Optics, 2000]. In this solution depressions (pits for ROM-type media and tracks for WORM- and RW-type media) on the surface of the data layers are filled with fluorescent solution. The solution, being agitated by the writing laser, emits incoherent light waves at the wavelength that is different from the wavelength of the reading laser. This allows for lower interlayer optical interference, and increases maximum number of possible layers. This, in turn allows for higher disk capacity.

The closest technical analogues to the present invention are optical fluorescent multilayer disks of ROM- and WORM-type, as described in U.S. Pat. Nos. 6,039,898; 6,309,729; 5,370,970; and 6,383,596. While layer capacity of one layer is lower compared to DVD (about 3.8 GB), higher capacity is achieved by multilayer structure.

### SUMMARY OF THE INVENTION

The present invention now increases data density that can be recorded and stored on an optical media, whether single or multilayer in nature, in the shape of disk, card, tape or any other form. This benefit is achieved by creating certain different pit or groove sizes as well as by combining both reflective and fluorescent principle of reading/recording data. While pits or grooves can be used, combinations of pits and grooves can also be used together.

In particular, the invention relates to an optical medium comprising a substrate layer, a protective layer and at least one data carrying layer situated between the substrate and protective layers, with the at least one data layer having a combined structure of optical data-carrying pits comprising a first plurality of relatively deeper pits and a second plurality of relatively shallower pits, with the first pits having a depth that is at least twice that of the shallower pits to reduce or avoid cross-interference when reading data from the pits. Preferably, all of the pits include fluorescent material therein.

In an embodiment, the first and second pluralities of pits are arranged sequentially on a single spiral track spreading from a central portion of the medium to a peripheral portion. Alternatively, the first plurality of pits can be arranged in one spiral track while the second plurality of pits can be arranged in a second spiral track adjacent to first track with both tracks spreading from a central portion of the medium to a peripheral portion.

Advantageously, the first plurality of pits contain fluorescent material and the second plurality of pits contain reflective, partially-reflective, metallic, semiconductor or dielectric material. It is also possible for the first plurality of pits to also contain some reflective, partially-reflective, metallic, semiconductor or dielectric material in an upper portion thereof. A partially-reflective metallic, semiconductor or dielectric layer can be provided on a surface of the data layer for additional performance.

Also, the invention relates to an optical medium comprising a substrate layer, a protective layer and at least one data carrying layer situated between the substrate and protective layers, with the at least one data layer having a combined structure of data-carrying grooves comprising a first plurality of relatively deeper grooves and a second plurality of relatively shallower grooves, with the first grooves having a depth that is at least twice that of shallower grooves to reduce or avoid cross-interference when reading data from grooves after the writing of data.

The grooves are arranged on a double spiral track spreading from a central portion of the medium to a peripheral portion.

Advantageously, the first plurality of grooves contains fluorescent material and the second plurality of grooves contain reflective, partially reflective, metallic, semiconductor or dielectric material. It is also possible for the first plurality of grooves to also contain some reflective, partially-reflective, metallic, semiconductor or dielectric material in an upper portion thereof. A partially reflective metallic, semiconductor or dielectric layer can be provided on a surface of the data layer for additional performance.

Also, the invention relates to an optical medium comprising a substrate layer, a protective layer and at least one data carrying layer situated between the substrate and protective layers, with the at least one data layer having a combined structure of data-carrying pits and grooves comprising a plurality of relatively deeper grooves and a plurality of relatively shallower pits, with the grooves having a depth that is at least twice that of shallower pits to reduce or avoid cross-interference when reading data from grooves after writing of data.

Also, the invention relates to an optical medium comprising a substrate layer, a protective layer and at least one data carrying layer situated between the substrate and protective layers, with the at least one data layer having a combined structure of data-carrying pits and grooves comprising a plurality of relatively deeper pits and a plurality of relatively shallower grooves, with the pits having a depth that is at least twice that of shallower grooves to reduce or avoid cross-interference when reading data from grooves after writing of data.

Advantageously, the deeper plurality of grooves or pits contains fluorescent material and the shallower plurality of grooves or pits contain reflective, partially reflective, metallic, semiconductor or dielectric material. It is also possible for the first plurality of grooves or pits to also contain some reflective, partially reflective, metallic, semiconductor or dielectric material in an upper portion thereof. A partially reflective metallic, semiconductor or dielectric layer can be provided on a surface of the data layer for additional performance.

The optical medium may further comprise several data layers and a separating layer between each pair of adjacent data layers, with the separating layer made of a material that is transparent to reading or writing of data in at least the first plurality of pits. The separating layers are typically made of a polymer material and the first plurality of pits have a refraction value that is different from that of the polymer separating layers.

In a desirable arrangement, the first plurality of pits or grooves have widths greater than those of the second plurality of pits. Additionally, the first plurality of pits or grooves may have depths that are 3 to 4 times greater than those of the second plurality of pits. In particular, for a red laser the first plurality of pits or grooves have depths of between 425 and 475 nm and the second plurality of pits or grooves have depths of between 75 and 125 nm, while for a blue laser, the first plurality of pits or grooves have depths of between 200 and 250 nm and the second plurality of pits have depths of between 25 and 75 nm.

The invention also relates to a method of reading data from the optical medium disclosed herein, which comprises generating and focusing a reading beam on the data layer to generate optical data signals from the first and second pluralities of pits; and separately measuring data from the first and second pluralities of pits by providing registration and focusing of the optical data signals that were generated. The registration and focusing may be accomplished by separately sensing the optical data signals from the first and second pluralities of pits.

As the first plurality of pits or grooves typically includes fluorescent material and the second plurality of pits or grooves typically includes a reflective material, the signal generated by the fluorescent material is detected by a fluorescent sensor and the signal generated by the reflective material is detected by a different sensor. When the first and second plurality of pits are situated in a single spiral track in the optical medium, the data is read sequentially using the different sensors. When the first and second plurality of pits are situated in different spiral tracks in the optical medium, the data can be read simultaneously by the different sensors.

Another embodiment relates to a reading device for such media, wherein the device also capable of reading traditional optical disks based on fluorescent or optical principles. This device comprises a component for generating and focusing a reading beam on the data layer to generate optical data signals from the first and second pluralities of pits; and sensors for separately measuring data from the first and second pluralities of pits by providing registration and focusing of the optical data signals that were generated. The signal generated by the fluorescent material in the pits of the optical medium is detected by a fluorescent sensor and the signal generated by the reflective material in the pits of the optical medium is detected by a different sensor.

Preferably, an actuator and lens focuses the reading beam on the data layer or layers, and a set of an element with a dichroic coating and semitransparent mirror; and an aberrational distortion corrector may also be included. The sensors can be part of an optical data signal reading unit that has two independent channels for separately registering the fluorescent and reflective optical signals and for separately forming an electric data signal and an electric focusing signal.

Generally, optical filters are provided on each data signal reading channel, and each reading channel contains a beam splitter that divides the fluorescent and reflective signals and targets them towards their respective sensor. Also, each reading channel can contain data processing units and focus tracking units.

As a further enhancement, the device can include two sets of elements with dichroic coatings and semitransparent mirrors; aberrational distortion correctors; and optical elements that combine reflective and fluorescent beams into one single channel. Alternatively, the element can split the reading beam in two, and combine optical data signals into parallel channels that are targeted towards their respective sensors.

### BRIEF DESCRIPTION OF THE DRAWINGS

The nature of the discussed invention is illustrated below in the set examples and figures, which do not limit in any way the described technical solutions and embodiment disclosed herein:

FIG. 1 shows schematic structure of traditional optical disk data layer;

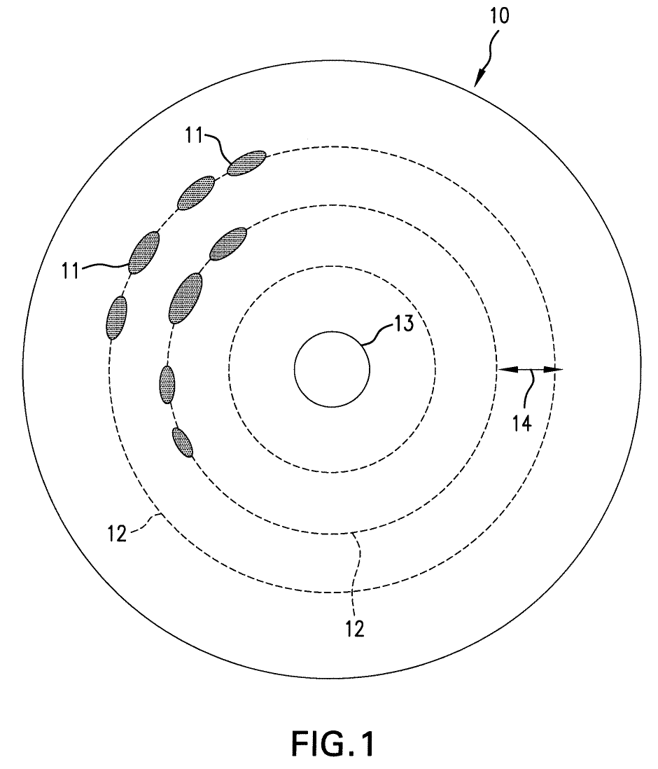

FIG. 2 shows schematic cross-section of variant combined fluorescent-reflective media disk;

FIG. 3 shows schematic cross-section of a different variant combined fluorescent-reflective media disk, where both fluorescent and reflective data is stored in one and the same track;

FIG. 4 shows schematic structure of a different variant combined fluorescent-reflective media disk;

FIGS. 5a and 5b shows microview of the surface of the combined fluorescent-reflective media (a) showing cross-cut (b) showing image from atomic-force microscope. The arrows indicate depth of fluorescent and reflective pits.

FIG. 6 shows schematic structure of layer of combined fluorescent-reflective WORM media disk with first plurality relatively deeper grooves and second plurality of relatively shallower grooves;

FIG. 7 shows schematic structure of layer of combined fluorescent-reflective ROM-WORM media disk with first plurality relatively deeper grooves and second of relatively shallower pits;

FIG. 8 shows schematic structure of layer of combined fluorescent-reflective ROM-WORM media disk with first plurality relatively deeper pits and second of relatively shallow grooves.

### DETAILED DESCRIPTION OF THE PREFERRED EMBODIMENTS

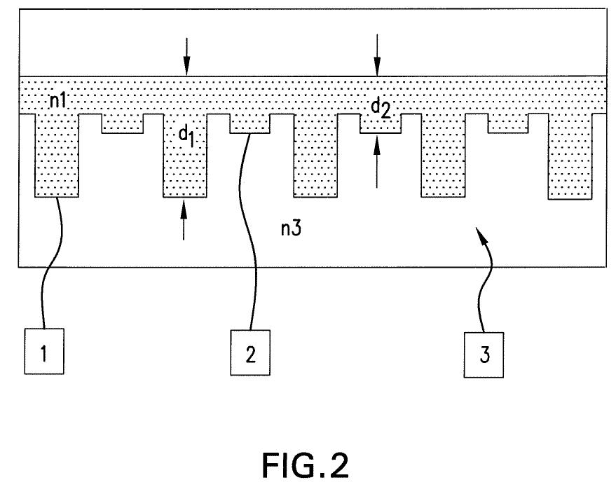

FIG. 2 shows schematic image of cross-cut of suggested variant construction of combined fluorescent-reflective optical disk of the invention. In this example data is stored as pits of different depths, situated in two alternating spiral tracks and one of the tracks, for example (1), contains deeper pits filled with fluorescent solution, while the other (2) contains shallower pits, where data is stored using reflective principle. Distance between tracks of similar type (1 or 2) is slightly more than in standard disk of this type (CD, DVD, HD DVD, BD, etc.).

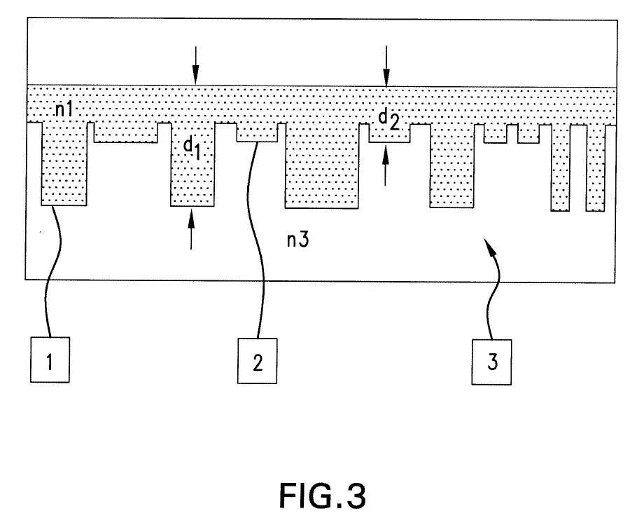

Another variant is possible, when both fluorescent and reflective pits are situated in the same spiral track. FIG. 3 shows schematic image of longitudinal cross-cut of combined fluorescent-optical data track. Data on such disk is recorded as pits of different depths, situated in one track. The deeper pits (1) are filled with fluorescent solution, and data is read from them using the fluorescent principle, while the shallower pits (2) are read using the reflective principle.

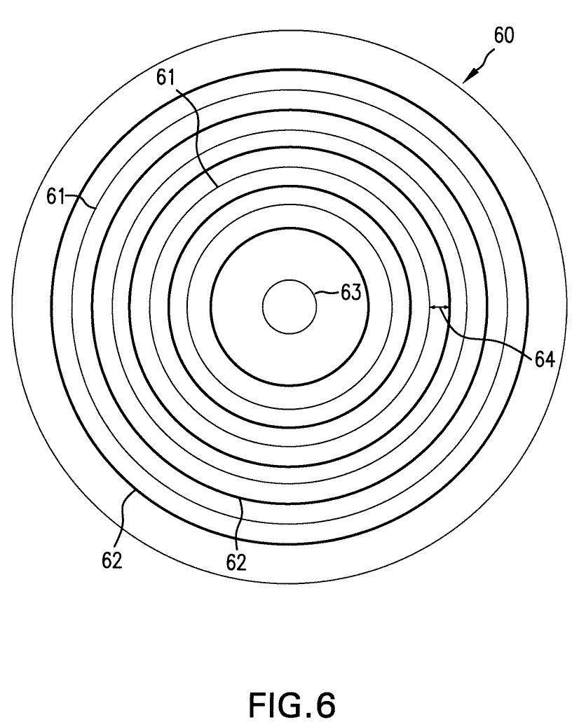

Another variant is possible with WORM-type disk, where grooves of different depth are used instead of pits, filled with solution, allowing laser beam-writing. FIG. 6 shows schematically WORM data layer (60) with grooves of different depth. The shallow and thin grooves (61) are filled with reflective solution, used in reflective data reading, while deep and thick grooves (62) are filled with fluorescent material. Distance between the grooves (track) (64) is close to the standard of the disks to this type.

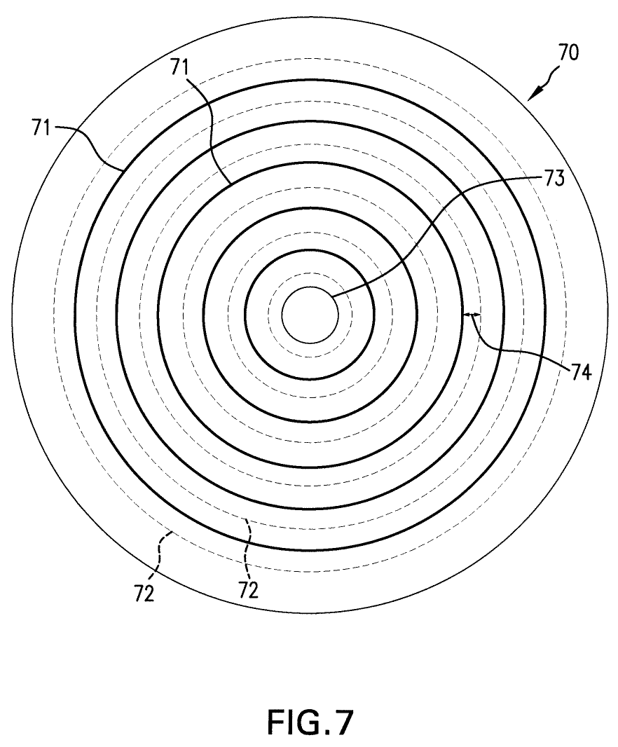

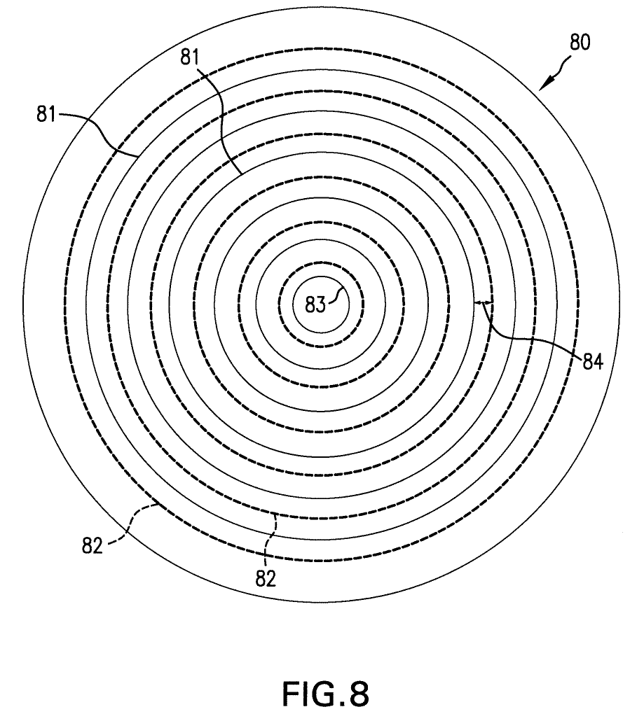

Another option is to use pits and grooves in the adjacent tracks of the same data layer, as shown on FIGS. 7 and 8. FIG. 7 shows data layer (70) containing shallow and thin pits (72) in one track and filled with partially-reflective solution, and deeper and thicker grooves (71) filled with fluorescent material. FIG. 8 shows data layer (80) with deep and thin pits (82) filled with fluorescent material and thinner and shallower grooves (81) with reflective material. Track distance between pits and grooves (73 and 83) is close to the standard of the disks to this type.

Another option is to include shallow grooves containing reflective RW-type media, and deep grooves containing fluorescent WORM-type media. Also data layer with pits and grooves, RW-type media can be used in thin grooves, and pits can be filled with fluorescent media.

In multilayer disks data layers can be of the same type (e.g. all WORM or all ROM) or mixed type (e.g. alternately ROM-WORM).

To reduce cross-interference from data-carrying pits, the fluorescent elements (1) are situated significantly deeper than reflective elements (2), at least 3-4 times. Depth of fluorescent elements is defined by this expression:

Condition of land and pit 1 reflective addition:

d₁=λNᵢ/2n₃; (2)

Condition of land and pit 2 reflective subtraction:

d₂=λ(Nᵢ+½)/2n₃, (3)

where

d₁ and d₂—depth of fluorescent and reflective pits, accordingly;

λ—reading laser wavelength;

n₁ and n₃—index of refraction of fluorescent media in pits and tracks (1) and separating layer (3), transparent for recording (in case of WORM and ROM type disks) and reading (fluorescent) beam, and

Nᵢ—integers.

From expressions (2) and (3) follows that difference between optical thickness of fluorescent data pits or tracks and optical thickness of reflective data pits or tracks must be odd number of ¼ wavelength of reading beam. A skilled artisan can calculate this for any particular reading beam. A red beam has been used for years but recently a blue beam has been found to provide higher resolution.

A stamper is made with a combination of small and large bumps. These are used to make the pits. As noted herein, these pits can be made in a single spiral track or two separate tracks.

A glass substrate is provided with a layer of an unpolymerized photoresist. The stamper is pressed into the photoresist and UV light is provided to polymerize the photoresist and form the pits. The stamper is removed to expose the pits. The size of the pits is dependent upon the type of laser that will be used to read the information in the pits.

For a red laser, the large pits are made with a depth of 450 nm, plus or minus 10 nm, while the smaller pits are made with a depth of 95 nm, plus or minus 10 nm. For a blue laser, the large pits are made with a depth of 225 nm, plus or minus 10 nm, while the smaller pits are made with a depth of 50 nm, plus or minus 10 nm.

Data elements of deep and shallow spirals are filled with polymer solution containing fluorescent dye, as described for example, in U.S. Pat. Nos. 6,338,935 and 6,835,431; or in EP application 1419047. Rhodamine type dyes are preferred.

To obtain required emission intensity in reflective mode index of refraction of fluorescent media n₁ is chosen to be different from index of refraction of separating layers n₃. Composition of fluorescent media (and, consequently, index of refraction of fluorescent media n₁) stays the same for all data layers, while the composition of separating layer 3 (and, consequently, index n₃) changes from one fluorescent layer to another, to keep reflected emission intensity on the same level for all data layers.

It is also possible to use standard method of reflective data surface creation—partially-reflective metallic, dielectric or semiconductor layers, as described in U.S. Pat. No. 5,449,590 and EP application 1419503. In this case refraction index of fluorescent media n₁ and refraction index of separating layer n₃ can be the same.

Two variants for data reading are described: the first variant uses consecutive reading, e.g. first only fluorescent signal is read and after that the reflective signal is read. The second variant uses simultaneous reading from both optical channels: fluorescent and reflective.

During reading of fluorescent signal, both fluorescent and reflective signal are used for focus tracking. Fluorescent signal is formed as described in U.S. Pat. Nos. 6,039,898 and 6,309,729.

During reading of reflective signal, focus tracking can be done using both with fluorescent and reflective signal. Reflective signal is formed as described in previously mentioned US patent by reflection of the signal from margin between data layer and separating layer with different refraction values n₁ and n₃.

Cross-interference between fluorescent and reflective tracks can be decreased by situating fluorescent and reflective tracks at different depth, with fluorescent element depth calculated using formulas (2) and (3) shown above, and by increasing distance between tracks. This enables the layers to be smaller thus allowing more data to be stored in the disk.

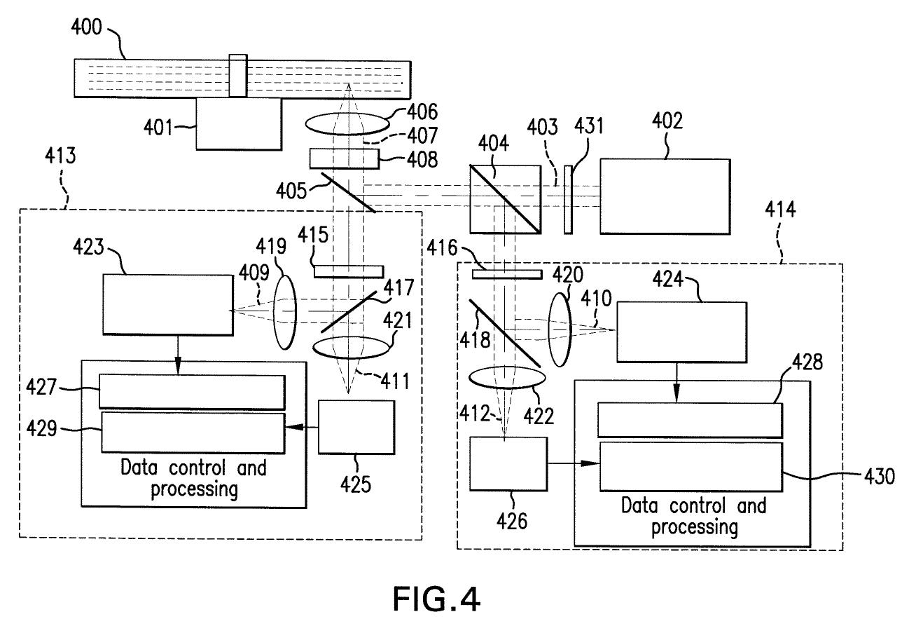

FIG. 4 shows schematic of variant device for reading from reading combined fluorescent-reflective media (400) on spindle (401). The reading emission source is laser (402). The beam (403) passes though dichroic element (404) and than is reflected by semitransparent mirror (405) to actuator with micro-objective (406) that forms reading beam (407), focused on data layer i of medias carrier (400).

Special static or dynamic corrector (408) (for example, liquid-crystal SLM) is used to compensate aberrational distortions caused by high-aperture lens (proportional to NA⁴) and to increase reading stability.

Data is read from such combined media as reflective (409) and fluorescent (410) emission and tracking signal for focus and data-track (411 and 412 respectively), is register by appropriate intensively sensors, of reflective (413) and fluorescent (414) emission.

These sensors contain optical filters (415 and 416) that filter out fluorescent emission and reading laser emission, respectively, beam splitters (417 and 418) that in turn using lens (419, 420, 421 and 422) aim reflected and fluorescent emission at the appropriate receivers (423 and 424) and servodetectors (425 and 426). Elements (414 and 417) (and 416 and 418 respectively) can be functionally united.

After that, electric signals from respective photodetectors and transferred to the data processing units (427 and 428), and data-track and focus tracking units (429 and 430).

In case of reading data from combined media, where fluorescent and reflective pits are situated in one track, such device provides consecutive (time-alternating) reading with the simultaneous reading of the channels (413 and 414).

In case of reading data from combined media, where fluorescent and reflective are situated in separate tracks, such device provides consecutive reading, e.g., first the data in fluorescent pits is read, and after that only the data in the reflective pits is read, or vice versa, with consecutive work of sensors (413 and 414).

The described construction of reading device does not exhaust all possibilities, but only illustrates current technical solution. For example, above-described device can be upgraded with second set of aberrational distortions correctors and actuator with micro-objective. This will allow reading data simultaneously from fluorescent and reflective pits. In this variant, we can use only one set of reflective and fluorescent beam intensity sensors. Such device can contain combined optical elements, receiving optical and fluorescent data beam, created by two micro-objectives, in a single beam. This solution allows an increase in reading speed by 200%, compared to the traditional methods.

Another variant is possible. When a new optical element (431) is introduced into the laser beam (407), such as diffraction splitter, that separates a beam focused on data layer in two and combines fluorescent and optical emission into uniformly directed beams, aimed at appropriate sensors (413 and 414). Such construction allows simultaneous reading from both fluorescent and reflective pits, increasing reading speed two times, compared to the traditional methods.

Another positive characteristic of suggested construction that it also allows reading of traditional optic or fluorescent disks, thus making the reading device highly versatile and capable of handling many different types of optical media.

### EXAMPLES

### Example 1

### Combined Fluorescent-Reflective ROM Disk

In this example, a stamper is prepared and used to impact two spiral tracks, each having pits of different depth, length and width from the other. The stamper is used to manufacture the substrate using molding, photopolymerization or any other technology. The substrate is prepared with a refraction value n3. Standard methods can be used to make the surface of the substrate reflective, such as application of dielectric, metallic or semiconductor layers. After that, a multilayer or single layer disk is manufactured as described in U.S. Pat. Nos. 6,039,898 or 6,309,729 while adhering to the requirements stated herein.

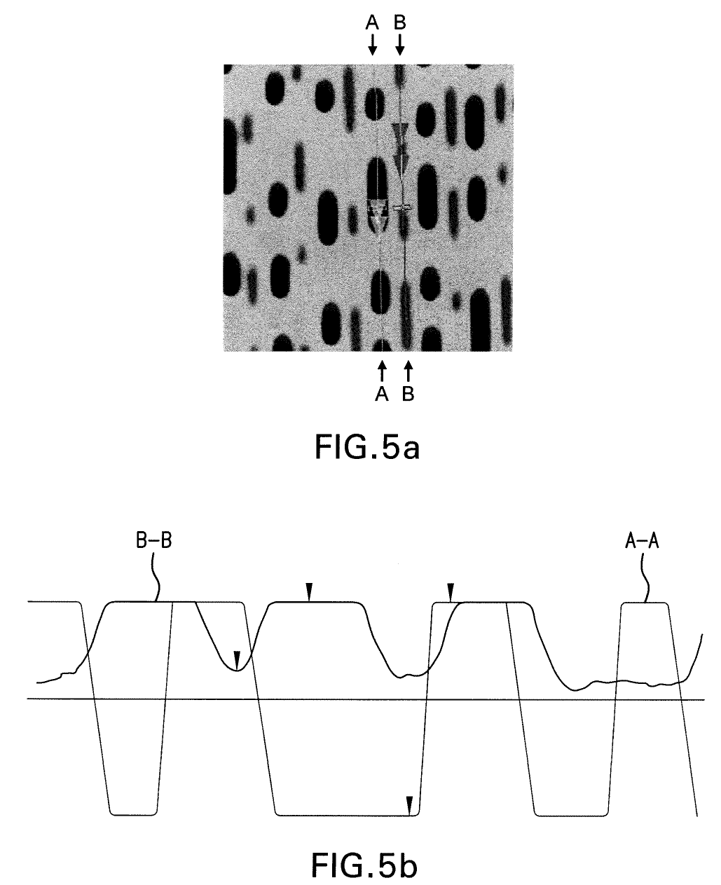

FIGS. 5a and 5b shows a microimage of surface of combined fluorescent-reflective disk (a) and its cross-section (b), made with atomic-force microscope. Cross-cuts are make along the A-A line for fluorescent tracks (as they are deeper and wider) and along the B-B line for reflective (as they are shallower and thinner), are shown on FIG. 5a.

Triangles in FIG. 5b show depth of fluorescent and reflective pits in respective tracks.

### Example 2

### A Combined Fluorescent-Reflective WORM-Disk

In WORM-type disk data elements are formed in the grooves of different depth by methods used in reflective and fluorescent WORM-type disks.

In this case, a stamper containing two spiral tracks with grooves of different depth is made. After that a substrate is made with grooves imparted by the stamper using molding, photopolymerization or any other technology, and depth of the groves is calculated using expressions (2) and (3).

After that the grooves are filled with a fluorescent dye, such as rhodamine and metallic layers such as silver are applied as described in U.S. Pat. Nos. 5,370,970 or 6,383,596. As a result a reflective WORM-type disk in the shallower grooves, while the deeper grooves remain almost empty of reflective material. After that the deeper grooves are filled with polymer composition with fluorescent dye and quencher layer is applied over it, as described in U.S. Pat. No. 6,721,257 or RU Patent 2,271,043.

Data is recorded as described in U.S. Pat. No. 6,721,257 or RU Pat. 2,271,043 for fluorescent tracks, and as described in U.S. Pat. No. 6,246,656 or US patent application 2005/0243693 for reflective tracks. Focus tracing during data recording is done via reflection for shallow grooves and via fluorescence for deeper grooves. Data is read in the same way as described above, for ROM-type disk.

What is claimed is:

1. An optical medium comprising a substrate layer, a protective layer and at least one data carrying layer situated between the substrate and protective layers, with the at least one data layer having a combined structure of optical data-carrying pits or grooves comprising a first plurality of relatively deeper pits or grooves and a second plurality of relatively shallower pits or grooves, with the first pits or grooves having a depth that is at least twice that of the shallower pits or grooves to reduce or avoid cross-interference when reading data.

2. The optical medium of claim 1, wherein all of the pits or grooves include fluorescent material therein.

3. The optical medium of claim 1, wherein the first and second pluralities of pits or grooves are arranged sequentially on a single spiral track spreading from a central portion of the medium to a peripheral portion.

4. The optical medium of claim 1, wherein the first plurality of pits or grooves are arranged in one spiral track while the second plurality of pits or grooves are arranged in a second spiral track adjacent to first track with both tracks spreading from a central portion of the medium to a peripheral portion.

5. The optical medium of claim 1, wherein the first plurality of pits or grooves contain fluorescent material and the second plurality of pits or grooves contain reflective, partially-reflective, metallic, semiconductor or dielectric material.

6. The optical medium of claim 5, wherein the first plurality of pits or grooves also contain some reflective, partially-reflective, metallic, semiconductor or dielectric material in an upper portion thereof.

7. The optical medium of claim 6, which further comprises a partially-reflective metallic, semiconductor or dielectric layer on a surface of the data layer.

8. The optical medium of claim 1, which further comprises several data layers and a separating layer between each pair of adjacent data layers, with the separating layer made of a material that is transparent to reading or writing of data in at least the first plurality of pits or grooves.

9. The optical medium of claim 8, wherein the separating layers are made of a polymer material and the first plurality of pits or grooves have a refraction value that is different from that of the polymer separating layers.

10. The optical medium of claim 1, wherein the first plurality of pits or grooves either have widths greater than those of the second plurality of pits or grooves or depths that are 3 to 4 times greater than those of the second plurality of pits or grooves.

11. The optical medium of claim 10, wherein for a red laser the first plurality of pits or grooves have depths of between 425 and 475 nm and the second plurality of pits or grooves have depths of between 75 and 125 nm while for a blue laser, the first plurality of pits or grooves have depths of between 200 and 250 nm and the second plurality of pits or grooves have depths of between 25 and 75 nm.

12. A method of reading data from the optical medium of claim 1, which comprises generating and focusing a reading beam on the data layer to generate optical data signals from the first and second pluralities of pits or grooves; and separately measuring data from the first and second pluralities of pits or grooves by providing registration and focusing of the optical data signals that were generated.

13. The method of claim 12, wherein the registration and focusing are accomplished by separately sensing the optical data signals from the first and second pluralities of pits or grooves.

14. The method of claim 13, wherein the first plurality of pits or grooves includes fluorescent material and the second plurality of pits or grooves includes a reflective material, such that the signal generated by the fluorescent material is detected by a fluorescent sensor and the signal generated by the reflective material is detected by a different sensor.

15. The method of claim 14, wherein the first and second plurality of pits or grooves are situated in a single spiral track in the optical medium and the data is read sequentially using the different sensors.

16. The method of claim 14, wherein the first and second plurality of pits or grooves are situated in different spiral tracks in the optical medium and the data is read simultaneously by the different sensors.

17. A device for reading data from the optical medium of claim 1, which comprises a component for generating and focusing a reading beam on the data layer to generate optical data signals from the first and second pluralities of pits or grooves; and sensors for separately measuring data from the first and second pluralities of pits or grooves by providing registration and focusing of the optical data signals that were generated.

18. The device of claim 17, wherein the first plurality of pits or grooves includes fluorescent material and the second plurality of pits or grooves includes a reflective material, such that the signal generated by the fluorescent material is detected by a fluorescent sensor and the signal generated by the reflective material is detected by a different sensor.

19. The device of claim 18, wherein an actuator and lens focuses the reading beam on the data layer or layers, and which further comprises a set of an element with a dichroic coating and semitransparent mirror; and an aberrational distortion corrector; and wherein the sensors are part of an optical data signal reading unit that has two independent channels for separately registering the fluorescent and reflective optical signals and for separately forming an electric data signal and an electric focusing signal.

20. The device of claim 19, further comprising an optical filters on each data signal reading channel.

21. The device of claim 19, wherein each reading channel contains a beam splitter that divides the fluorescent and reflective signals and targets them towards their respective sensor.

22. The device of claim 19, wherein each reading channel contains data processing units and focus tracking units.

23. The device of claim 18, wherein an actuator and lens focuses the reading beam on the data layer or layers, and further comprising two sets of elements with dichroic coatings and semitransparent mirrors; aberrational distortion correctors; and optical elements that combine reflective and fluorescent beams into one single channel.

24. The device of claim 17, which further comprises an optical element that splits the reading beam in two, and combines optical data signals into parallel channels that are targeted towards their respective sensors.

25. The device of claim 17, which is also capable of reading traditional fluorescent and reflective disks.
